(19) United States
(12) Patent Application Publication
(10) Pub. No.: US 2006/0293067 A1
(43) Pub. Date: Dec. 28, 2006

(54) Method and apparatus for controlling sleep intervals of a mobile unit

(76) Inventors: Kin K. Leung, London (GB); Sayandev Mukherjee, Plainsboro, NJ (US); George E. Rittenhouse, Holmdel, NJ (US)

Correspondence Address: WILLIAMS, MORGAN & AMERSON, 10333 RICHMOND, SUITE 1100, HOUSTON, TX, 77042, US

(21) Appl. No.: 11/167,435

(22) Filed: Jun. 27, 2005

(51) Int. Cl. H04Q 7/20

(52) U.S. Cl. 455/458; 455/41.2; 370/328

(57) ABSTRACT

The present invention provides a method of wireless communication with a base station. The method may include providing a resource request message comprising information indicative of entry into a sleep mode and receiving an acknowledgment from the base station in response to providing the resource request message.

### BACKGROUND OF THE INVENTION

1. Field of the Invention

This invention relates generally to communication systems, and, more particularly, to wireless communication systems.

2. Description of the Related Art

Wireless networks are used to provide wireless connectivity to subscriber stations, which may also be referred to as user equipment, mobile units, and the like. Exemplary subscriber stations include cellular telephones, personal data assistants, smart phones, text messaging devices, laptop computers, desktop computers, and the like. A typical wireless network includes one or more base stations (also commonly referred to as access points or node-Bs) that provide wireless connectivity to subscriber stations in a particular geographic area or cell. For example, IEEE 802.11 wireless local area networks have been widely deployed and used to provide wireless service to subscriber stations located in airports, offices, homes, and other locations.

Building on the success of wireless local area networks, wireless metropolitan area networks (MANs) are being developed to provide wireless connectivity over larger geographic areas. For example, the IEEE 802.16 standard (now generally referred to as the 802.16-2001 standard) specifies the air interface and medium-access-control (MAC) protocols for wireless metropolitan area networks. Wireless metropolitan area networks are designed to provide broadband wireless access to buildings through external antennas communicating with radio base stations. The wireless metropolitan area network may therefore offer an alternative to fiber optic links, cable modems, and/or digital subscriber loops. Home and/or business users may be connected directly to telecommunication networks and Internet via radio links of the wireless metropolitan area network.

Wireless local area networks and wireless metropolitan area networks may operate according to standards that assume that the wireless users are either fixed or mobile. For example, the 802.16a standard approved in 2003 to support non-line-of-sight radio links in both licensed and unlicensed frequency bands from 2-11 GHz was devised primarily for fixed wireless users. The 802.16a standard was subsequently revised to create the 802.16d standard (now referred to as the 802.16-2004 standard), which is viewed as a promising alternative for providing last-mile connectivity by radio link. As a result, many large and small companies are actively developing and testing 802.16-2004 products.

The subscriber stations in fixed wireless networks are assumed to have access to a power source, e.g., via a power cord connected to a wall socket or power strip. Thus, fixed wireless network standards typically do not provide features intended to extend battery life, at least in part because the lifetime of a battery in the subscriber station of a fixed wireless network is not considered a limiting factor for the operation of the subscriber station. For example, the 802.16-2004 standard does not provide a mechanism for putting the subscriber station to sleep, at least in part because the 802.16-2004 standard was proposed for stationary subscriber stations and it was assumed that power supply for the subscriber stations would not be a critical issue. The 802.16-2004 standard also lacks a paging signal that may be used to wake a sleeping subscriber station.

In contrast, conserving battery power is a critical issue for mobile subscriber stations such as cellular phones, personal data assistants, smart phones, text messaging devices, and the like. Consequently, fixed wireless network standards (such as the 802.16-2004 standard) do not provide sufficient support for mobile subscriber stations. In particular, fixed wireless network standards lack crucial support for sleeping and/or waking mode operations that may be used to conserve battery power in mobile subscriber stations.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the instant invention, a method of wireless communication with a base station is provided. The method may include providing a resource request message comprising information indicative of entry into a sleep mode and receiving an acknowledgment from the base station in response to providing the resource request message.

In another embodiment of the present invention, a method of wireless communication with a subscriber station is provided. The method may include receiving a resource request message comprising information indicative of entry into a sleep mode from the subscriber station and providing an acknowledgment in response to providing the resource request message.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a wireless communication system, in accordance with the present invention;

FIG. 2 conceptually illustrates a subscriber station and the base station that may be used in the wireless communication system shown in FIG. 1, in accordance with the present invention;

FIG. 3A conceptually illustrates a method of entering a sleep mode, in accordance with the present invention; and

FIG. 3B conceptually illustrates a method of waking up a subscriber station, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

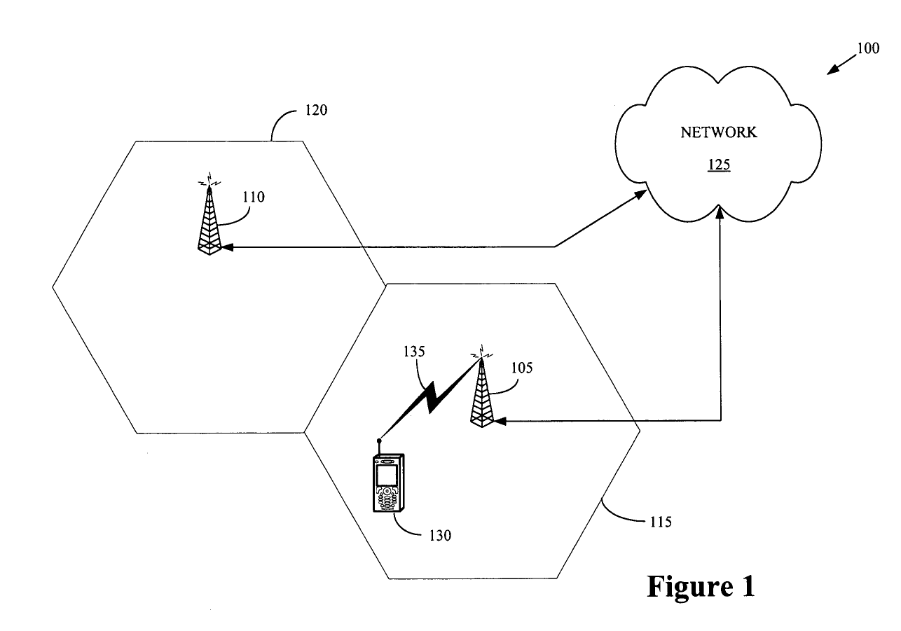

FIG. 1 conceptually illustrates a wireless communication system 100. In the illustrated embodiment, one or more base stations 105, 110 (also commonly referred to as access points or node-Bs) provide wireless connectivity to associated geographic areas, or cells 115, 120. Although two base stations 105, 110 are shown in FIG. 1, persons of ordinary skill in the art should appreciate that the present invention is not limited to two base stations 105, 110. In alternative embodiment, any desirable number of base stations 105, 110 may be used. The base stations 105, 110 are communicatively coupled to a network 125. In various alternative embodiments, the network 125 may include a wired and/or wireless network such as a Universal Mobile Telecommunication System (UMTS), a Global System for Mobile communication (GSM), a Public Switched Telephone Network (PSTN), and the like.

The wireless communication system 100 may include one or more subscriber stations 130 (only one shown), which may be mobile. Exemplary subscriber stations 130 may include cellular telephones, personal data assistants, smart phones, text messaging devices, handheld scanners, laptop computers, desktop computers, and the like. The subscriber station 130 can communicate with the base station 105 over an air interface 135. In the illustrated embodiment, the air interface 135 is established according to a fixed user standard. As used herein in accordance with common usage in the art, the phrase “fixed user standard” refers to standards that assume that the subscriber station 130 is stationary or moving at velocities smaller than typical walking speeds. Accordingly, fixed wireless network standards may assume that the subscriber station 130 has access to a substantially continuous external power supply, such as a wall socket or a battery that may be recharged whenever necessary or substantially continuously. One example of a fixed user standard is the 802.16-2004 standard. In one embodiment, the air interface 135 is formed according to the 802.16-2004 standard.

Mobile subscriber stations 130 do not typically have substantially continuous access to an external power supply. For example, cellular phones include batteries that supply power while being transported and used by a user. However, cellular phones may be separated from an external power source for long periods relative to the expected life of the battery. At least in part to conserve battery power, the subscriber station 130 may, in one embodiment, be put to sleep. As used herein in accordance with common usage in the art, the phrase “putting to sleep” refers to killing processes running on the subscriber station 130 that are not necessary to sustain a connection over the air interface 135. For example, when the subscriber station 130 is asleep, the subscriber station 130 may run a small number of processes to “listen” to one or more channels occasionally to maintain connectivity over the air interface 135. However, fixed wireless network standards such as the 802.16-2004 standard typically do not provide support for either putting the subscriber station 130 to sleep or for waking up the subscriber station 130. For example, the 802.16-2004 standard does not provide signaling messages for indicating that the subscriber station 130 is to be put to sleep or woken up, or functionality to interpret sleep/wake signaling messages.

Accordingly, the subscriber station 130 may provide a resource request message that includes information indicating that the subscriber station 130 is entering into a sleep mode. As used herein, the term “resource request message” should be understood to indicate a message requesting a certain amount of a resource that may be provided by the wireless communication system 100. Accordingly, the resource request message may include information indicative of the resource being requested and information indicative of the amount of the resource requested. For example, a bandwidth request message may include a request to use a certain amount of bandwidth to transmit and/or receive information, such as voice and/or data. Exemplary resources that may be requested using a resource request message include, but are not limited to, channel codes or frequencies, sub-bands, and time slots.

The resource request message provided by the subscriber station 130 may include a request for a null or zero amount of the requested resource. Since resource request messages typically include information indicating a certain amount of the resource, resource request messages that request a null or zero amount of the associated resource may be ignored or considered errors by a conventional wireless communication system. The base station 105 may, however, interpret the request for the null or zero amount of the resource as an indication that the subscriber station 130 is entering into a sleep mode, as will be discussed in detail below. The base station 105 may then provide an acknowledgment to the subscriber station 130, which may then go to sleep. In one embodiment, the sleeping subscriber station 130 may also be woken up, e.g., after a fixed time period or in response to a paging message from the base station 105, as will be discussed in detail below.

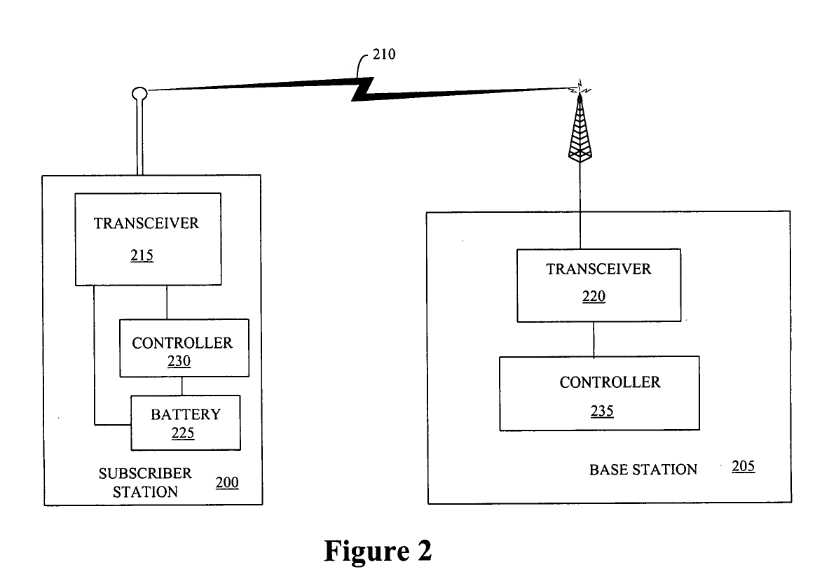

FIG. 2 conceptually illustrates a subscriber station 200 and a base station 205 that may be used in the wireless communication system shown in FIG. 1. In the illustrated embodiment, the subscriber station 200 and the base station 205 communicate over an air interface 210, which operates according to a fixed user standard, as discussed above. The subscriber station 200 includes a transceiver 215 for transmitting and/or receiving messages over the air interface 210. The base station 205 also includes a transceiver 220 for transmitting and/or receiving messages over the air interface 210. Although the transceivers 215, 220 are depicted as single entities in FIG. 2, persons of ordinary skill in the art should appreciate that the transceivers 215, 220 may be implemented in any desirable number of entities. For example, the transceivers 215, 220 may be implemented as separate transmitters and receivers.

The subscriber station 200 includes a battery 225 that provides power to operate portions of the subscriber station 200, such as the transceiver 215 and a controller 230. The controller 230 may determine that it is desirable to put the subscriber station 200 to sleep. For example, the controller 230 may decide to put the subscriber station to sleep based on a level in the battery 225. For another example, the controller 230 may decide to put the subscriber station 200 to sleep based on an elapsed time, which may be determined using a clock (not shown). The controller 230 may then form a resource request message that includes information indicating that the subscriber station 130 is entering into a sleep mode, such as a request for a null or zero amount of the resource. In various alternative embodiments, the controller 230 may be implemented in hardware, firmware, software, or any combination thereof. The resource request message may be transmitted over the air interface 210 using the transceiver 215.

The base station 205 may receive the transmitted resource request message using the transceiver 220 and a controller 235 may use the receive resource request message to determine that the subscriber station 200 intends to go to sleep. The controller 235 may therefore form an acknowledgment message in response to receiving the resource request message, which may be provided to the subscriber station 200 over the air interface 210 using the transceiver 220. The controller 235 may also provide paging messages to the subscriber station 200 using the transceiver 220. The paging messages may be used to wake up the sleeping subscriber station 200, as will be discussed in detail below.

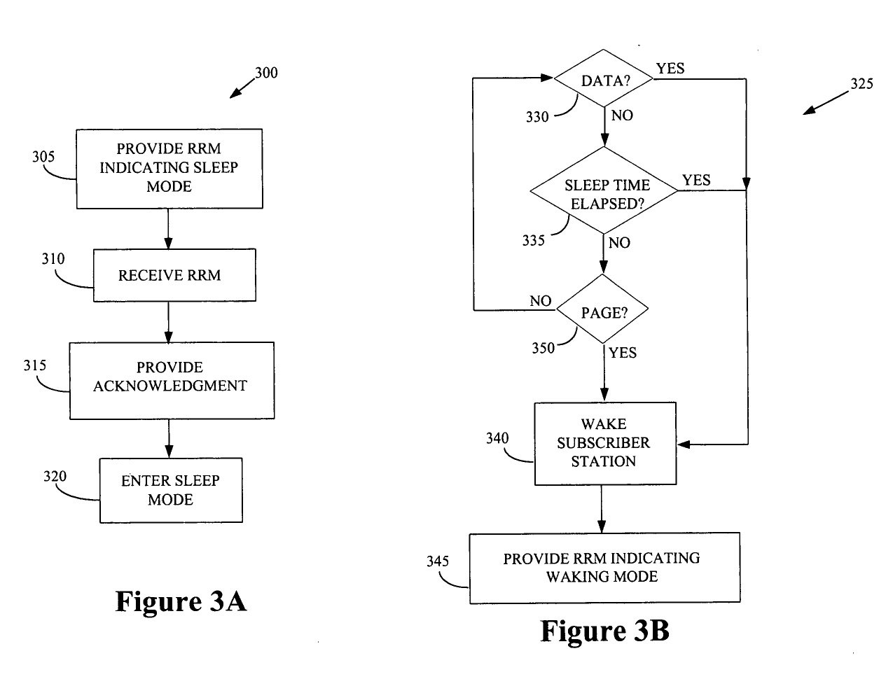

FIG. 3A conceptually illustrates one exemplary embodiment of a method 300 of entering a sleep mode. The exemplary embodiment of the method 300 is described in the context of communication between a subscriber station and a base station according to the 802.16-2004 standard. However, persons of ordinary skill in the art should appreciate that the present invention is not limited to the 802.16-2004 standard. In alternative embodiments, any desirable standard, including future versions or modifications of the 802.16-2004 standard, may be used. In the illustrated embodiment, the decision to enter the sleep mode is initiated by the subscriber station. The algorithm that the subscriber station applies to arrive at this decision is arbitrary and can be specific to that subscriber station while being unknown to the base station. For example, the subscriber station may decide that it should enter the sleep mode based on a lack of traffic on the downlink and uplink channels.

The subscriber station may provide (at 305) a resource request message indicating that it will be entering a sleep mode. In one embodiment, the subscriber station uses a Connection Identifier (CID) belonging to one of its current sessions to send a Bandwidth Request (BR) message to the base station. The Bandwidth Request message that is provided (at 305) requests zero additional bandwidth. The base station receives (at 310) the resource request message, which the base station interprets the request for zero additional bandwidth as a request for permission to enter the sleep mode. One advantage of using a Bandwidth Request message with 0-byte request to request permission to enter the sleep mode is that if the base station is not enabled to support this sleep/wakeup function, then a request for an additional bandwidth of zero bytes will simply be ignored or discarded, thereby causing no changes to the current session.

The base station may then provide (at 315) an acknowledgment that it has received the request and has approved entering the sleep mode. In one embodiment, the base station acknowledgment includes a pre-specified Uplink Interval Usage Code (UIUC) that serves as an acknowledgment to the subscriber station that it is allowed to enter into the sleep mode. The specific UIUC may be known and/or hard-wired in the base station and subscriber station. On receipt of this acknowledgement message from the base station, the subscriber station enters (at 320) the sleep mode. In one embodiment, the subscriber station enters (at 320) the sleep mode after a fixed time interval, which may be measured by a clock or in a number of frames. The fixed time interval is set by the network operator and is known to both the base station and the subscriber station. This obviates the need to transmit the fixed time interval defining the sleep start time from base station to subscriber station or vice versa, thereby eliminating the need to change the standard to accommodate a message that transmits this information.

During the sleep mode, the subscriber station maintains frame synchronization (this is one of the few processes that are maintained during the sleep mode). Further, the subscriber station may decode downlink information periodically in order to check whether the subscriber station is being paged by the base station, as described below. The period between downlink decoding operations (e.g., once every 5 frames) may be pre-defined by the network operator and hard-wired in the subscriber station. Battery energy may be conserved because the subscriber station only decodes data occasionally. Note that from the perspective of the base station, the subscriber station may be treated just the same as if it were not in the sleep mode, with the exception that the base station may not transmit data to a sleeping subscriber station without first ensuring that the subscriber station has been woken up. The session parameters associated with a sleeping subscriber station may be retained. The sleep period may not be indefinite, but may continue only for a fixed time period or a finite number of frames, after which the subscriber station may wake up by default, if it has not already been woken up by a paging message sent from the base station, or by the arrival of data at the subscriber station intended for transmission on the uplink. This maximum sleep duration may also be pre-determined, fixed, and/or set by the network operator and assumed known to both base station and the subscriber station.

FIG. 3B conceptually illustrates one exemplary embodiment of a method 325 of waking up a subscriber station. As discussed above, the exemplary embodiment of the method 325 is described in the context of communication between a subscriber station and a base station according to the 802.16-2004 standard. In the illustrated embodiment, the subscriber station determines (at 330) whether there is any data to send on the uplink to the base station. If the subscriber station determines (at 330) that no data is available to send on the uplink, the subscriber station may also determine (at 335) whether or not a sleep time has elapsed. For example, the subscriber station may determine (at 335) whether not a clock timer has expired or whether a predetermined number of frames have passed.

If there is data available to send on the uplink and/or if a sleep time has elapsed, the subscriber station wakes up (at 340) by reviving some or all of the processes that were running before the subscriber station entered the sleep mode. The subscriber station may then transmit the data just as it would have if it had never entered the sleep mode. Since the base station retained all session parameters when the subscriber station first entered the sleep mode, the base station is ready to receive the data and does so. The arrival of this data from the subscriber station may alert the base station to the fact that the sleeping subscriber station has now woken up. Alternatively, the sleeping subscriber station may provide (at 345) a resource request message indicating that it is now operating in a waking mode. The base station may then treat the subscriber station as if it is no longer in the sleep mode.

In one alternative embodiment, the subscriber station may determine (at 350) that the base station has provided a paging message indicating that the subscriber station should wake up. For example, the base station may wake up a sleeping subscriber station by transmitting a paging message during one of the periodic frames that is received and decoded by the subscriber station. This type of paging message is not supported by the current 802.16-2004 standard. However, the standard permits network operators to use several UIUCs to define modulation and/or coding rates (burst profiles) for Orthogonal Frequency Division Multiplexing (OFDM and/or OFDMA) modes of operation. The network operator may therefore reserve one of these UIUCs for use as a paging message.

In one embodiment, the base station specifies a CID associated with the subscriber station scheduled for wakeup in one or more uplink maps (UL-MAPs) transmitted by the base station over a number of consecutive frames. The transmitted UL-MAPs may employ the UIUC designated for paging purposes with the most robust modulation and coding scheme available, at least in part because the subscriber station may only be receiving and decoding periodic frames during sleep mode. Furthermore, since the sleeping subscriber station may not transmit information on the uplink, the base station has little or no information about downlink channel quality and cannot tailor its coding scheme accordingly. Thus, if the downlink channel suffers degradation, the subscriber station may not receive the base station transmission, so robust modulation/coding with repetition maximizes the chance of the subscriber station receiving the paging message.

Upon receiving the UIUC information in the UL-MAP, the subscriber station wakes up (at 340). To confirm with the base station that the subscriber station has indeed exited the sleep mode, the subscriber station may transmit (at 345) another resource request message, such as a bandwidth request message with 0 bytes in the Bandwidth Request field. The receipt of this message by the base station may be interpreted by the base station as an acknowledgement by the subscriber station that it has now woken up and resumed normal operation.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication with a base station, comprising:
providing a resource request message comprising information indicative of entry into a sleep mode; and
receiving an acknowledgment from the base station in response to providing the resource request message.

2. The method of claim 1, wherein providing the resource request message comprises providing the resource request message according to a fixed user standard.

3. The method of claim 1, wherein providing the resource request message comprises providing the resource request message according to an 802.16-2004 standard.

4. The method of claim 1, wherein providing the resource request message comprises providing a bandwidth request message.

5. The method of claim 4, wherein providing the bandwidth request message comprises providing a bandwidth request message using a connection identifier associated with a session.

6. The method of claim 1, wherein providing the resource request message comprises providing information indicative of a request for a null or zero amount of a resource.

7. The method of claim 1, wherein receiving the acknowledgment comprises receiving an acknowledgment including information indicating that the base station has permitted entry into the sleep mode.

8. The method of claim 7, wherein receiving the acknowledgment comprises receiving an acknowledgment including a preselected Uplink Interval Usage Code indicating that the base station has permitted entry into the sleep mode.

9. The method of claim 1, further comprising entering the sleep mode in response to receiving the acknowledgment.

10. The method of claim 9, wherein entering the sleep mode comprises entering the sleep mode a fixed time interval after receiving the acknowledgment.

11. The method of claim 9, further comprising waking up after entering the sleep mode.

12. The method of claim 11, wherein waking up after entering the sleep mode comprises waking up a fixed time period after entering the sleep mode.

13. The method of claim 11, further comprising receiving a paging message from the base station.

14. The method of claim 13, wherein receiving the paging message comprises receiving a preselected Uplink Interval Usage Code.

15. The method of claim 13, wherein waking up after entering the sleep mode comprises waking up in response to receiving the paging message.

16. The method of claim 13, further comprising providing a resource request message including information indicating exit from the sleep mode substantially after waking up.

17. A method of wireless communication with a subscriber station, comprising:
receiving a resource request message comprising information indicative of entry into a sleep mode from the subscriber station; and
providing an acknowledgment in response to the resource request message.

18. The method of claim 17, wherein receiving the resource request message comprises receiving the resource request message according to a fixed user standard.

19. The method of claim 17, wherein receiving the resource request message comprises receiving the resource request message according to an 802.16-2004 standard.

20. The method of claim 17, wherein receiving the resource request message comprises receiving a bandwidth request message.

21. The method of claim 20, wherein receiving the bandwidth request message comprises receiving a bandwidth request message using a connection identifier associated with a session.

22. The method of claim 17, wherein receiving the resource request message comprises receiving information indicative of a request for a null or zero amount of a resource.

23. The method of claim 17, wherein providing the acknowledgment comprises providing an acknowledgment including information indicating permission to enter the sleep mode.

24. The method of claim 23, wherein providing the acknowledgment comprises providing an acknowledgment including a preselected Uplink Interval Usage Code indicating permission for the subscriber unit to enter the sleep mode.

25. The method of claim 17, further comprising receiving a resource request message including information indicating that the subscriber unit has exited from the sleep mode.

26. The method of claim 25, wherein the resource request message including information indicating that the subscriber unit has exited from the sleep mode is received a fixed time interval after the acknowledgment is provided.

27. The method of claim 17, further comprising providing a paging message indicating a request to wake up the subscriber station.

28. The method of claim 27, wherein providing the paging message comprises providing a preselected Uplink Interval Usage Code.

29. The method of claim 27, further comprising receiving a resource request message including information indicating that the subscriber unit has exited from the sleep mode in response to providing the paging message.
